(19) United States
(12) Patent Application Publication
(10) Pub. No.: US 2008/0119309 A1
(43) Pub. Date: May 22, 2008

(54) HYDRAULIC TRACTION ELEMENT TENSIONER WITH INTEGRATED TENSION-FORCE LIMITING

(75) Inventors: Roman Kern, Forchheim (DE); Marco Kowalski, Herzogenaurach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/943,766

(22) Filed: Nov. 21, 2007

(30) Foreign Application Priority Data
Nov. 21, 2006 (DE) 102006054744.6

(51) Int. Cl. F16H 7/08

(52) U.S. Cl. 474/109

(57) ABSTRACT

Traction element tensioner (1), which is preferably a hydraulic traction element tensioner for a chain drive, with a housing (2), which holds a tensioning piston (3) that can move axially and that is adjacent to a tensioner high-pressure space (4). The tensioner high-pressure space (4) is fed via a fluid supply opening (5) and also a non-return valve (6). The traction element tensioner (1) includes a valve assembly, which is constructed as a pressure-limiting valve (7) and limits a fluid pressure in the tensioner high-pressure space (4).

### BACKGROUND

The present invention relates to a traction element tensioner, especially according to a type of hydraulic traction element tensioner for a chain drive, with a housing, which holds a tensioning piston that can move axially and that is adjacent to a tensioner high-pressure space, wherein the tensioner high-pressure space is supplied via a fluid supply opening and also a non-return valve. The invention relates, in particular, to a traction element tensioner working with pressurized oil for a chain drive, which is used in internal combustion engines for transmitting the rotational movement of a crankshaft to at least one camshaft and also to other assemblies operated by the internal combustion engine.

From the laid-open, unexamined application DE 10 2004 047 450 A1, a hydraulic traction element tensioner according to the class is known, which is designed for tensioning a traction element. The construction of the traction element tensioner disclosed herein comprises a housing, which is constructed at least partially cylindrically and in which a tensioning piston of an associated machine part is guided so that it can move axially. The cylinder-forming part of the housing and the tensioning piston delineate a tensioner high-pressure space filled with a hydraulic fluid, wherein for an adjustment movement of the tensioning piston, a volume exchange of the hydraulic fluid between the tensioner high-pressure space and a storage space constructed in the tensioning piston is realized via a non-return valve arranged at the end in the tensioning piston. The fitting dimensions of the tensioning piston guided in the housing are constructed so that for an adjustment of the piston in the direction of the pressure space, hydraulic fluid can escape into the storage space via a leakage gap between the piston and the housing. For the reverse adjustment movement of the tensioning piston, hydraulic fluid flows from the storage space into the pressure space via the non-return valve arranged on the base side in the pressure space.

In the operation of traction element tensioners in the field of internal combustion engines for transferring the rotational motion between the crankshaft and the camshaft or external assemblies, the problem arises that the traction element tensioner is exposed to a considerable dynamic load. The dynamic load relates to the generation of vibrations introduced into the tensioning piston on the part of the traction element. For damping and maintaining the necessary tension force, the hydraulic fluid flows via a fluid supply opening within the housing through the non-return valve into the tensioner high-pressure space. Because a continuous fluid pressure is applied via the fluid supply opening, for a vibrating movement superimposed onto the tensioning piston, a pressure excess is produced in the tensioner high-pressure space. The reason lies especially in the high flow resistance in the leakage gap between the tensioning piston and the housing, so that the tensioning piston cannot be retracted back into the housing fast enough. Thus the tensioning piston wanders farther from the housing when the overall system vibrates and the traction element is tensioned with an excessively large tension force. This operating state can lead to a failure of the traction element. For vibration amplitudes, for example, of 1 mm, tension forces of up to 2 kN can be realized at a vibrating frequency of 400 Hz. Thus, the maximum permissible tension forces of the traction element tensioner on the traction element, such as, for example, the chain drive, is increased by a multiple, which could lead to failure of the chain drive, resulting, in a known way, in considerable damage to the internal combustion engine.

### SUMMARY

Therefore, the object of the present invention is to improve a traction element tensioner of the type described above and to prevent impermissibly excessive tension forces on the traction element due to the tensioning piston. In particular, the object of the present invention is to provide pressure limiting in the tensioner high-pressure space also when the traction element tensioner vibrates.

This object is met with a traction element tensioner according to the invention. Advantageous improvements of the invention are specified in the specification and claims.

The invention includes the technical teaching that the traction element tensioner comprises a valve assembly, which is constructed as a pressure-limiting valve and which limits the fluid pressure set in the tensioner high-pressure space.

The advantage achieved through the expansion of a traction element tensioner by a valve assembly acting as a pressure-limiting valve is the limitation of the pressure of the hydraulic fluid set in the tensioner high-pressure space. If the pressure of the hydraulic fluid in the tensioner high-pressure space reaches a preset threshold, then the pressure-limiting valve opens, so that the hydraulic fluid can escape not only through the leakage gap formed between the tensioning piston and the housing, but a large volume flow can also escape through the pressure-limiting valve from the tensioner high-pressure space within a short time span.

According to an especially advantageous embodiment of the arrangement of the valve assembly, it is provided that the pressure-limiting valve is arranged in the tensioning piston. The tensioning piston offers sufficient installation space for a pressure-limiting valve on the side facing away from the tensioner high-pressure space, wherein the high-pressure inlet opening of the pressure-limiting valve can be connected easily to the tensioner high-pressure space. The connection can be formed, for example, as a longitudinal borehole in the tensioning piston, so that a permanent connection of the pressure-limiting valve with the tensioner high-pressure space is guaranteed.

Advantageously, the pressure-limiting valve comprises a valve slide, which is guided in a valve slide space in a direction of a valve slide longitudinal axis and can be brought into a closed position by a valve spring. This embodiment of a pressure-limiting valve corresponds to a typical construction of a slide valve, wherein for moving the valve slide into an open position, the high fluid pressure acts upon a pressure surface formed on one end on the valve slide, so that the pressure of the hydraulic fluid acts against the valve spring. If the fluid pressure reaches a threshold, then the valve spring is greatly compressed, so that a blow-off opening of the pressure-limiting valve is opened. For maintaining a desired threshold pressure within the tensioner high-pressure space, a corresponding passage cross section within the pressure-limiting valve is set between the high-pressure inlet opening and the blow-off opening.

According to another advantageous embodiment of the pressure-limiting valve, the tensioning piston can move along a tensioning piston longitudinal axis, wherein the valve slide longitudinal axis and the tensioning piston longitudinal axis enclose an angle of 60° to 120°, preferably 75° to 105°, and especially preferred 90° relative to each other. Through this proposed arrangement of the valve slide of the pressure-limiting valve, the valve slide longitudinal axis runs perpendicular to the vibrating direction of the tensioning piston, so that the pressure-limiting valve is arranged within the tensioning piston in a way that is not sensitive to vibrations. The vibration amplitude acting at a right angle to the valve slide longitudinal axis generates no mass moments of inertia of the valve slide, because due to this arrangement, the mass moments of inertia of the valve slide do not act in a direction of the valve slide longitudinal axis.

Advantageously, the valve slide is sealed in the valve slide space by its fit and/or by a sealing element. Especially advantageous is a clearance fit, by which the valve slide is fit within the valve slide space. A small leakage flow of the hydraulic fluid between the valve slide and the guide in the valve slide space can be considered acceptable, because a continuous adjustment flow of the hydraulic fluid is realized through the fluid supply opening into the tensioner high-pressure space. A further improved construction of the arrangement of the valve slide within the valve slide space with a certain leakage flow can replace the necessary leakage between the tensioning piston and the housing, as provided in previous constructions of traction element tensioners. Thus, the geometric construction of the transition between the housing and the tensioning piston, which is very complicated in terms of production, is no longer necessary for the construction of a certain leakage flow, because the leakage flow can be formed within the pressure-limiting valve.

The traction element tensioner introduces the tension force into the traction element via a tensioning bracket, wherein the pressure-limiting valve is arranged within the tensioning piston at the end of the tensioning piston adjacent to the tensioning bracket. In particular, it can be provided that it has a blow-off opening for discharging the hydraulic fluid from the tensioner high-pressure space in the direction of the tensioning bracket, wherein the escaping hydraulic fluid can be forwarded into or through the tensioning bracket.

The traction element tensioner according to the invention can be constructed with a tension spring arranged in the tensioner high-pressure space, so that the tension spring acts between the housing and the tensioning piston, wherein the tension spring extends at least partially into the tensioning piston. The tensioning piston is initially biased against the traction element by the tension spring. The tension spring causes the actual application of the tension force into the traction element, wherein the hydraulic fluid is applied preferably for damping.

According to another advantageous embodiment of the invention, it is provided that the pressure-limiting valve comprises an adjustment spring, which applies force to the valve slide in a direction of the open position, wherein the magnitude of the force application can be changed through adjustment to or with the adjustment spring. The adjustment spring acts against the valve spring, so that the valve slide has not only a monostable arrangement within the pressure-limiting valve. The adjustment spring can be adjusted preferably manually or by the use of hydraulic fluid in the biasing, so that as a function of the desired maximum fluid pressure within the tensioner high-pressure space, the pressure-limiting valve enables a fluid connection between the high-pressure inlet opening and the blow-off opening either at lower fluid pressures or first at higher fluid pressures, in order to blow the hydraulic fluid from the tensioner high-pressure space when the threshold pressure is reached.

According to another advantageous embodiment of the arrangement of the pressure-limiting valve within the tensioning piston, the valve assembly constructed as the pressure-limiting valve is a screw-in unit that can be screwed into the tensioning piston at the end and/or pressed into this piston. As an alternative to a construction that can be screwed in, the screw-in unit can also be fixed within the tensioning piston by a snap ring or the like. The screw-in unit comprises, overall, a cylindrical construction, wherein the first flat surface of the cylinder points in the direction of the tensioner high-pressure space, and the second flat surface of the cylinder forms the pressure surface of the tensioning piston, for example, against the tensioning bracket. The geometric construction of the tensioning piston, especially for holding the tension spring, can be realized in various ways. For example, the tensioning piston can be constructed, so that the tension spring is directly adjacent to the screw-in unit. Thus, the tensioning piston is constructed, overall, like a hollow cylinder, so that the tensioner high-pressure space is directly adjacent to the screw-in unit.

### BRIEF DESCRIPTION OF THE DRAWINGS

Additional measures improving the invention will now be described in more detail below together with the description of a preferred embodiment of the invention with reference to the figures. Shown are:

FIGS. 1a, 1b views showing the arrangement of a traction element tensioner according to the present invention, wherein FIG. 1a shows the unit of the traction element tensioner in the arrangement of the entire traction element drive from FIG. 1b at an enlarged scale;

FIG. 2a a view of the pressure-limiting valve within the tensioning piston in a closed position;

FIG. 2b a view of the pressure-limiting valve within the tensioning piston in an open position;

FIG. 3a a view of another embodiment of the pressure-limiting valve with an adjustment spring in a closed position; and

FIG. 3b a view of the embodiment of the pressure-limiting valve within a tensioning piston with an adjustment spring in an open position.

### DETAILED DESCRIPTION OF THE PREFERRED EMBODIMENTS

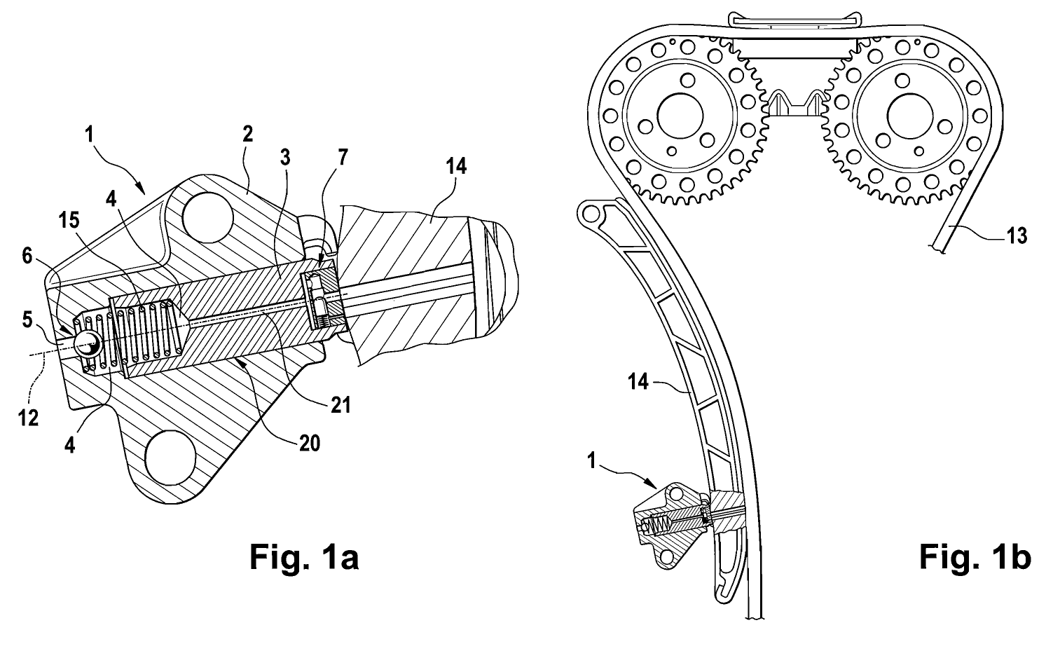

The traction element tensioner according to the present invention is shown in enlarged form in FIG. 1a and is provided with the reference symbol 1. FIG. 1b shows an arrangement of the traction element tensioner 1 in the overall system of the traction element drive, wherein the traction element 13 is biased by a tensioning bracket 14 and the traction element tensioner 1 acts against the tensioning bracket 14. The traction element tensioner 1 is shown in FIG. 1a in cross section, wherein the traction element tensioner 1 first comprises a housing 2, in which a tensioning piston 3 is held so that it can move along a tensioning piston longitudinal axis 12. A tension spring 15 is arranged between a rear end of the housing 2 and the tensioning piston 3, and applies a pressure force on the tensioning piston 3, so that this is pressed in the direction of the tensioning bracket 14. Furthermore, the housing 2 comprises a tensioner high-pressure space 4, which is pressurized with a hydraulic fluid via a fluid supply opening 5 and a non-return valve 6, adjacent to the tensioning piston 3. The non-return valve 6 comprises a valve body, which is shown schematically as a ball and which is sealed against the fluid supply opening 5. Now, if the hydraulic fluid flows from the fluid supply opening 5 into the tensioner high-pressure space 4, then the valve element of the non-return valve 6 prevents a reverse flow of the hydraulic fluid. Thus, the tensioner high-pressure space 4 is continuously pressurized and presses the tensioning piston 3 against the tensioning bracket 14. For the escape of the hydraulic fluid from the tensioner high-pressure space 4, a leakage gap 20 is provided, through which the hydraulic fluid can escape in correspondingly small amounts.

According to the invention, a pressure-limiting valve 7 is arranged within the tensioning piston 3 on the end facing the tensioning bracket 14. The pressure-limiting valve 7 is connected via a fluid channel 21 to the tensioner high-pressure space 4. If the fluid pressure within the tensioner high-pressure space 4 assumes a critical value, then the pressure-limiting valve 7 opens and the hydraulic fluid can pass through the fluid channel 21 out of the pressure-limiting valve 7 and can escape from the tensioner high-pressure space 4. This guarantees that the fluid pressure within the tensioner high-pressure space 4 cannot reach super-critical values, so that the traction element 13 cannot be overloaded due to too strong a biasing force via the tensioning bracket 14.

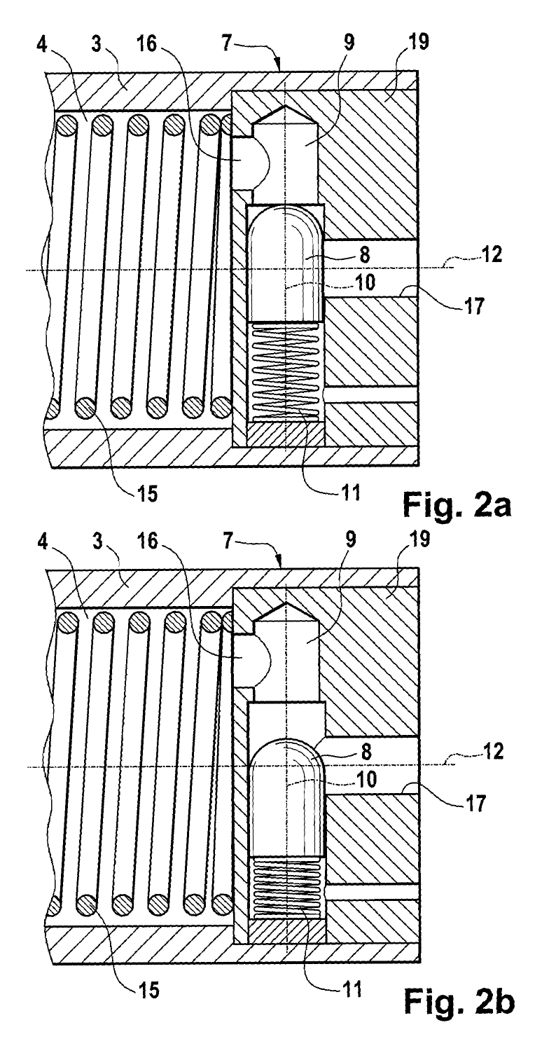

In FIGS. 2a and 2b, the pressure-limiting valve 7 is shown in an enlarged view. This is located within the tensioning piston 3, wherein the pressure-limiting valve 7 is shaped in the form of a screw-in unit 19 in the end of the tensioning piston 3 adjacent to the tensioning bracket. According to the construction shown here, the tension spring 15 is directly adjacent to the screw-in unit 19 forming the pressure-limiting valve 7. On the inside, the screw-in unit 19 delineates the tensioner high-pressure space 4, wherein the screw-in unit 19 is adjacent on the outside to the tensioning bracket.

The pressure-limiting valve 7 comprises a valve slide 8, which is held within a valve slide space 9 so that it can move axially. Through a high-pressure inlet opening 16, the valve slide space 9 is pressurized with the fluid pressure from the tensioner high-pressure space 4, wherein a valve spring 11 presses the valve slide 8 into a closed position. In FIG. 2a, the pressure-limiting valve 7 is shown in a closed position, wherein FIG. 2b shows the pressure-limiting valve 7 in an open position. Thus, it is visible in FIG. 2b that the valve slide 8 within the valve slide space 9 in an open position opens the high-pressure inlet opening 16 and connects it to a blow-off opening 17, so that the hydraulic fluid can be led from the tensioner high-pressure space 4 within the tensioning piston 3 through the high-pressure inlet opening 16 and the valve slide space 9 to the blow-off opening 17. The valve slide 8 is arranged so that it can move longitudinally along a valve slide longitudinal axis 10, which is perpendicular to the tensioning piston longitudinal axis 12. This guarantees that vibration movements within the tensioning piston 3, which are generated along the tensioning piston longitudinal axis 12, do not act directly on the valve slide 8. The reason for the insensitivity of the valve slide 8 to vibrations is based on the fact that the direction of vibrations is perpendicular to the direction of motion along the valve slide longitudinal axis 10 of the valve slide 8. Thus, no mass moments of inertia of the valve slide 8 are generated and the pressure-limiting valve 7 can operate without influence from the dynamic load.

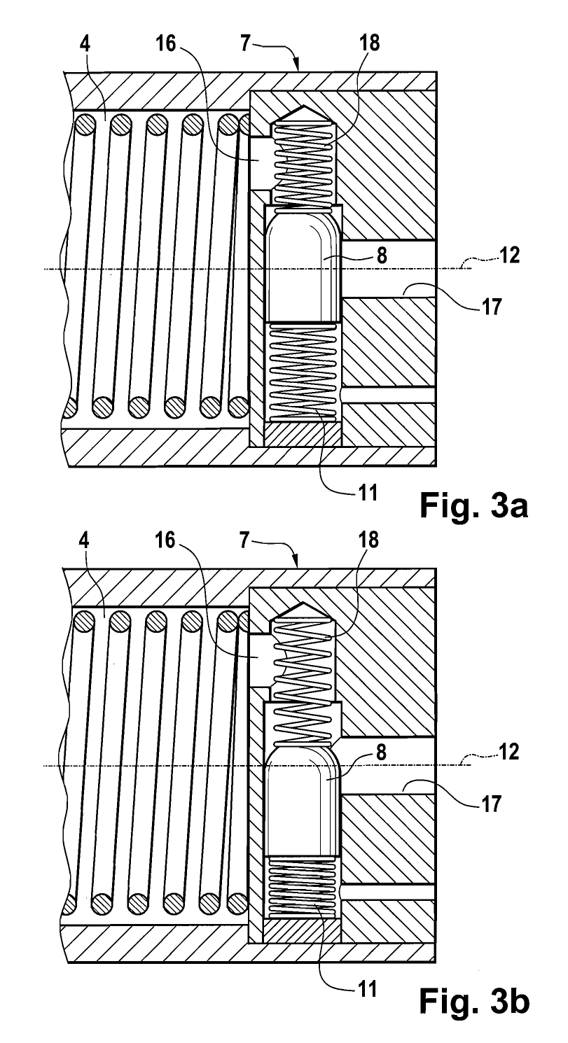

In FIGS. 3a and 3b, another embodiment of the pressure-limiting valve 7 is shown. Here, an adjustment spring 18 is shown adjacent to the valve slide 8, wherein in FIG. 3a the pressure-limiting valve is shown in a closed position and in FIG. 3b in an open position. Through the use of the adjustment spring 18 there is the possibility of setting the maximum permissible fluid pressure from the tensioner high-pressure space 4, in which the valve slide 8 is moved into an open position. The adjustment spring 18 constructed as a compression spring here supports the transition of the valve slide 8 into an open position, so that the pressure-limiting valve 7 is constructed not only as a monostable valve. If the adjustment spring 18 loses tension, then the valve spring 11 is compressed, wherein when the valve spring 11 loses tension, the adjustment spring 18, in contrast, is compressed. Thus the two springs 11 and 18 act in opposite directions.

The invention is not limited in its construction to the preferred embodiment specified above. Instead, many other variants are conceivable, which also use constructions that are fundamentally different than the shown solution. The valve slide 8 is shown according to the present embodiments as a cylindrical valve slide with a correspondingly spherical end. However, there is also the possibility to construct the valve slide 8 as a ball element or the like, which can realize an identical or at least similar effect for forming a closed or open position. Furthermore, the springs, comprising the valve springs 11 and also the adjustment springs 18, are not restricted to the construction of a spiral spring. Furthermore, there is the possibility of using spring elements, which have different constructions and which can comprise, for example, plate springs, leaf springs, or other elastic elements. Also the arrangement of the pressure-limiting valve 7 within the end of the tensioning piston adjacent to the tensioning bracket 14 is not to be understood as a limitation of the present scope of protection. The pressure-limiting valve 7 can also be arranged within the housing 2 of the traction element tensioner 1 as long as the tensioner high-pressure space 4 can be vented in terms of pressure via the pressure-limiting valve 7.

### LIST OF REFERENCE SYMBOLS

1 Traction element tensioner
2 Housing
3 Tensioning piston
4 Tensioner high-pressure space
5 Fluid supply opening
6 Non-return valve
7 Pressure-limiting valve
8 Valve slide
9 Valve slide space
10 Valve slide longitudinal axis
11 Valve spring
12 Tensioning piston longitudinal axis
13 Traction element
14 Tensioning bracket
15 Tension spring
16 High-pressure inlet opening
17 Blow-off opening
18 Adjustment spring
19 Screw-in unit
20 Leakage gap
21 Fluid channel

1. Traction element tensioner, comprising a housing, which holds a tensioning piston that can move axially and that is adjacent to a tensioner high-pressure space that is connected to a fluid supply through a non-return valve, and a pressure-limiting valve that limits the fluid pressure in the tensioner high-pressure space in communication therewith.

2. Traction element tensioner according to claim 1, wherein the pressure-limiting valve is arranged in the tensioning piston.

3. Traction element tensioner according to claim 2, wherein the pressure-limiting valve comprises a valve slide, which is guided in a valve slide space in a direction of a valve slide longitudinal axis and which biased toward a closed position by a valve spring.

4. Traction element tensioner according to claim 3, wherein the tensioning piston is movable in a direction of a tensioning piston longitudinal axis, and the valve slide longitudinal axis and the tensioning piston longitudinal axis are set at an angle of 60° to 120° to one another.

5. Traction element tensioner according to claim 3, wherein the valve slide is sealed in the valve slide space by at least one of a close tolerance fit or by a sealing element.

6. Traction element tensioner according to claim 1, wherein the traction element tensioner introduces the tension force into the traction element via a tensioning bracket, and the pressure-limiting valve is arranged in the tensioning piston on an end side of the tensioning piston adjacent to the tensioning bracket.

7. Traction element tensioner according to claim 1, wherein the tensioning piston is biased against the traction element by a tension spring arranged in the tensioner high-pressure space.

8. Traction element tensioner according to claim 3, wherein the pressure-limiting valve comprises a high-pressure inlet opening and a blow-off opening, and the high-pressure inlet opening is connected to the tensioner high-pressure space and the valve slide, and in an open position opens a connection between the high-pressure inlet opening and the blow-off opening.

9. Traction element tensioner according to claim 8, wherein the pressure-limiting valve comprises an adjustment spring, which applies a force on the valve slide in a direction of the open position, wherein a magnitude of the force application can be adjusted.

10. Traction element tensioner according to claim 1, wherein the pressure-limiting valve is a screw-in unit (19) and is screwed or pressed into the tensioning piston at an end thereof.

11. Traction element tensioner according to claim 1, wherein the traction element tensioner comprises a hydraulic traction element tensioner for a chain drive.

12. Traction element tensioner according to claim 4, wherein the valve slide longitudinal axis and the tensioning piston longitudinal axis are set at an angle of 75° to 105° to one another.

13. Traction element tensioner according to claim 4, wherein the valve slide longitudinal axis and the tensioning piston longitudinal axis are set at an angle of about 90° to one another.
